(19) United States
(12) Patent Application Publication
(10) Pub. No.: US 2003/0095655 A1
(43) Pub. Date: May 22, 2003

(54) Subscriber line interface device

(76) Inventors: Masaji Noguchi, Yokohama (JP); Takashi Nakano, Yokohama (JP); Tomohiro Ueno, Yokohama (JP); Takashi Nagato, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/108,170

(22) Filed: Mar. 27, 2002

(30) Foreign Application Priority Data
Nov. 22, 2001 (JP) 2001-357386

(51) Int. Cl. H04M 1/00; H04M 9/00

(52) U.S. Cl. 379/387.01; 379/413

(57) ABSTRACT

The object of the present invention is to provide a subscriber line interface device in which a spacing factor and feeding efficiency of the low-voltage power supply are improved. The subscriber line interface device according to the present invention is capable of feeding a plurality of subscriber terminals connected thereto, with different voltages, characterized in that it includes a (low) voltage power supply distributed to a plurality of subscriber line interface boards, each capable of connecting to a predetermined number k of the subscriber terminals, in order to feed with a voltage (for example, −30 VDC), the absolute value of which is lower than that of a maximum voltage (for example, −48 VDC) among the different voltages.

### BACKGROUND OF THE INVENTION

1. Field of the Invention

The present invention generally relates to a subscriber line interface device, more particularly, to a subscriber line interface device which feeds with a relatively low voltage to subscriber terminals within a comparatively close range, and feeds with a relatively high voltage to subscriber terminals besides the subscriber terminals within a comparatively close range.

2. Description of the Related Art

In recent years, the configuration of subscriber system networks accommodating telephones, etc. has become increasingly digitized, however, there are still significant demands for analog subscriber line transmission systems accommodating analog telephones and thus continuous technological innovation and improvement, in terms of down-sizing, low cost, etc., are required.

FIG. 7 through FIG. 9 show diagrams (1) through (3) for describing prior art. FIG. 7 shows a typical configuration of an analog subscriber line transmission system. As shown in the figure, the system includes a plurality of subscriber terminals (analog telephones, etc.) 1a, . . . , 1g, a switching center (switchboard) 10 connecting to the plurality of subscriber terminals, a remote terminal 20 located in a distant location (on side roads and locations in a building, etc.), and a public network 100. The switching center 10 includes a subscriber line interface section 11, a subscriber line interface board (SLIF) 12 for terminating analog (metallic) subscriber lines, an optical interface board (OPT) 13 for terminating fiber-optic lines, an off-hook channel switch (NSW) 14, an office line trunk section 15 for terminating office lines and dedicated lines, and a main control section 16 performing main controls of the switching center 10 (such as call processing, etc.). The remote terminal 20 includes an optical interface board (OPT) 21 for terminating fiber-optic lines and a subscriber line interface board (SLIF) 22 for terminating analog (metallic) subscribers lines.

The subscriber line interface section 11 takes up approximately 50% to 70% of the whole system configuration, in terms of cost,-mounting space, and power consumption, and conventionally, efforts have been made to achieve smaller and less expensive devices by downsizing and high-density mounting of the relevant circuits in this section.

FIG. 8 shows a block diagram of a conventional subscriber line interface section 11 (the same applies to the remote terminal 20). As shown, the subscriber line interface section 11 (per shelf) includes an MPU board 111 for performing a common control inside the subscriber line interface section 11, a TSA board 112 having a time slot assignment function of main signals (off-hook signals, etc.), a TEST board 114 for testing the subscriber lines and the circuits of subscriber line interface boards, an OPT board 13 for connecting to the remote terminal 20, a plurality of subscriber line interface (SLIF) boards 115 (maximum of 14 boards, from #1 through #14), each capable of connecting to 32 lines of analog subscriber terminals, and a +5 V PWR board 116 which receives an input from a −48 VDC power supply common to the system, to generate +5 VDC for feeding logic circuits within the shelf. The description on a −30 V PWR board 117 will be given later.

FIG. 9(B) shows a mounted external view of the conventional subscriber line interface section 11. The function blocks (boards) realizing each of the above-mentioned functions are configured by printed boards and mounted to a shelf (housing). It is noted that each subscriber terminal is basically fed from a feeding power supply −48 VDC, which is common to the system, and this power supply (not shown) is separately configured from the shelf. In this example, a maximum of 14 SLIF boards 115 are mounted to the shelf, therefore, a single shelf may connect to a maximum of 448 (=32×14) subscriber lines.

Down-sizing and high-density mounting of the subscriber-circuits in the subscriber line interface section 11 will provide an increase in the number of subscribers line that may be connected to the device but, at the same time, will result in an increase in the power consumption of the feeding power supply of −48 VDC, and thus generate a significant amount of heat in the device (subscriber line interface section 11). As a precaution against thus generated heat, an additional −30 V PWR board 117 has been provided conventionally, and a so-called battery-switching method has been adopted with which to feed a low-voltage (−30 VDC) for newly subscribed telephones within a relatively close range (i.e. telephones with low line loop resistance) and to feed a high-voltage (−48 VDC) for newly subscribed telephones at a relatively distant range (i.e. telephones with high line loop resistance).

FIG. 9(A) describes a conventional method of battery switching control. A loop current flows in a line (a subscriber line) via a subscriber telephone 1 depending on the off-hook condition (the subscriber is talking on the phone) of the subscriber telephone 1. It is assumed herein that a constant current of 24 mA is fed to a line (a telephone) in the off-hook condition (i.e. the line is busy or engaged). When the line loop resistance is below 1000 Ω (which means the subscriber telephone is within a relatively close range), then the line is fed with −30 VDC and when the line loop resistance is equal to or more than 1000 Ω (which means the subscriber telephone is at a relatively distant range), then the line is fed with −48 VDC. By doing so, since the power generated when feeding with −30 V is 0.27 W (=|−30 V|×24 mA) and the power generated when feeding with −48 V is 1.152 W (=|−48 V|×24 mA) , a saving of 0.432 W (=1.152 W−0.72 W) can be obtained when feeding with −30 V and thus the overall power consumption and the heat generation of the device itself can be suppressed.

Also, a power supply ability (feeding capacity) of the conventional −30 V PWR board 117 is set to the minimum, for saving cost, by taking into consideration a rate of line usage, which is a percentage of lines being currently used or busy out of all the available lines. For example, when the rate of line usage is approximately 10% for general-use and approximately 20% for business-use, then for the additionally provided −30 V PWR board 117, it may be set to 33%, giving a little margin. The rate of line usage of 33% means when, for example, 100 subscriber telephones are connected to the device, 33 out of the all subscriber telephones are in off-hook condition (which means 33 out of 100 subscriber telephones are busy) and the line loop current is flowing.

However, according to the prior art, the conventional −30 V PWR board 117 employs a centralized power supply method in which each subscriber line interface board #1 through #14 is fed from a single (or a common) −30 V PWR board 117, and therefore a physical spacing for mounting the additional −30 V PWR board 117 in the shelf is needed and this has prevented mounting of additional SLIF boards 115 in the shelf.

Also, even when the actual load (the number of SLIF boards 115 actually mounted in the shelf or the number of lines actually fed with −30 V) of −30 VDC is small, the feeding capacity of −30 V PWR board 117 is maintained and thus the power efficiency is low.

### SUMMARY OF THE INVENTION

In view of the problems according to the prior art, the object of the present invention is to provide a subscriber line interface device in which a spacing factor and feeding efficiency of the low-voltage power supply are improved.

The above object is achieved by, for example, a configuration shown in FIG. 1. A subscriber line interface device according to the present invention capable of feeding a plurality of subscriber terminals 1 connected thereto with different voltages is characterized in that a plurality of voltage power supplies 50 are distributed to each of a plurality of subscriber interface boards 315 respectively, each subscriber interface board 315 capable of connecting to a predetermined number k (for example, k=32) of the subscriber terminals 1, in order to feed a voltage (for example, −30 VDC), the absolute value of which is lower than that of a maximum voltage (for example, −48 VDC) among the different voltages.

The subscriber line interface device according to the present invention is advantageous, due to its distributed configuration, in that a conventional low-voltage power supply (−30 V PWER board) 117 that is centrally controlled is eliminated and an additional subscriber line interface board 315 can be provided in the space obtained by eliminating the conventional low-voltage power supply 117.

Also, since the subscriber line interface device according to the present invention is capable of increasing a feeding capacity of the voltage power supply 50 depending on the number of actual subscribers (i.e. the number of the subscriber line interface boards 315 actually mounted to a shelf) , it is not necessary to keep the feeding capacity of the −30 V PWER board 117 independently of the amount of load (the number of subscribers) and thus an efficiency of the (low) voltage power supply 50 in the whole system is improved.

In the subscriber line interface device according to the present invention, the feeding capacity of the voltage power supply 50 is preferably smaller than that needed for the predetermined number k of the subscriber terminals 1.

According to the present invention, by configuring the feeding capacity of the voltage power supply 50 as, for example, approximately 33% of the feeding capacity necessary to feed the predetermined number k of the subscriber terminals, in view of a rate of line usage, it is possible to make each voltage power supply compact and also the usage efficiency of the power supplied from the voltage power supply 50 is improved.

Further, in the subscriber line interface device according to the present invention, each voltage power supply 50 is operated in parallel with other voltage power supplies distributed to other subscriber line interface boards, having outputs of the respective voltage power supplies 50 interconnected.

As a result of which, even when the load (off-hook subscriber terminals within a relatively close range) concentrate 100% on the voltage power supply 50 in a particular subscriber line interface board 315, a feeding deficiency (−67%)of the relevant voltage power supply 50 can be covered by voltage power supplies 50 in other subscriber line interface boards 315, and thus a flexible routing of the low-voltage feeding and the usage efficiency of the voltage power supply 50 in a system are improved significantly.

In addition, in the subscriber line interface device 1 according to the present invention, the voltage power supply 50 is fed by a high-voltage power supply 60 generating a relatively high-voltage.

Therefore, even in a case of a deficiency of the feeding capacity of the low-voltage (voltage power supply 50), the feeding can be covered by the high-voltage feeding from the high-voltage power supply. Also, the high-voltage is not fed to the subscriber terminals fed with the low-voltage and vice versa, thus the total amount of the feeding capacity of the system (high-voltage power supply 60) is not wasted and it can be effectively used.

Further, in the subscriber line interface device 1 according to the present invention, it further includes a switch 64 that switches the feeding to the subscriber terminal 1 between the high-voltage power supply 60 and the low-voltage power supply 50 and a control unit 311 that monitors the line loop resistance of the subscriber lines and connects the switch 64 to the low-voltage power supply 50 for the subscriber terminals 1 with line loop resistance below a predetermined threshold, and connects the switch 64 to the high-voltage power supply 60 for the subscriber terminals 1 with line loop resistance over a predetermined threshold, and the control unit 311 is also configured not to connect the switch 64 to the low-voltage power supply 50 when the total amount of feeding of the low-voltage power supplies 50 to all subscriber terminals 1 exceeds the overall amount of feeding allowed to the relevant low-voltage power supplies 50.

As a result, each voltage power supply 50 can be effectively utilized up to its rated load. Also, by feeding from the high-voltage power supply 60 for those exceeding the rated load, the overloading of the voltage power supply 50 is effectively prevented. Also, the usage-efficiency of the voltage power supply 50 is improved.

From the above-listed advantages of the subscriber line interface device according to the present invention, an efficiency of (low) voltage feeding for each subscriber line and its reliability are improved. Also, the spacing factor-of the device is improved and as a result, the downsizing of the device or the increase in the total number of lines that can be connected to the device is realized.

### BRIEF DESCRIPTION OF THE DRAWINGS

Other objects, advantages, and further features of the present invention will become more apparent as the description proceeds taken in conjunction with the accompanying drawings which:

FIG. 1 shows a diagram describing a principle of the present invention;

FIG. 2 shows a block diagram of a subscriber line interface section in one embodiment of the present invention;

FIG. 3 shows a block diagram of a subscriber line interface board in one embodiment of the present invention;

FIG. 4 shows a circuit diagram of a subscriber circuit section in one embodiment of the present invention;

FIG. 5 shows an external view of a subscriber line interface section in one embodiment of the present invention;

FIG. 6 is a flow chart of a method of battery switching control in one embodiment of the present invention;

FIG. 7 shows a diagram (1) describing the prior art;

FIG. 8 shows a diagram (2) describing the prior art; and

FIGS. 9(A) and (B) show diagrams (3) describing the prior art.

### DETAILED DESCRIPTION OF THE PREFERRED EMBODIMENT

The following is a detailed description of preferred embodiments of the present invention, according to the accompanying drawings. Identical reference numerals have been used, where possible, to designate identical elements or equivalents that are common to the figures.

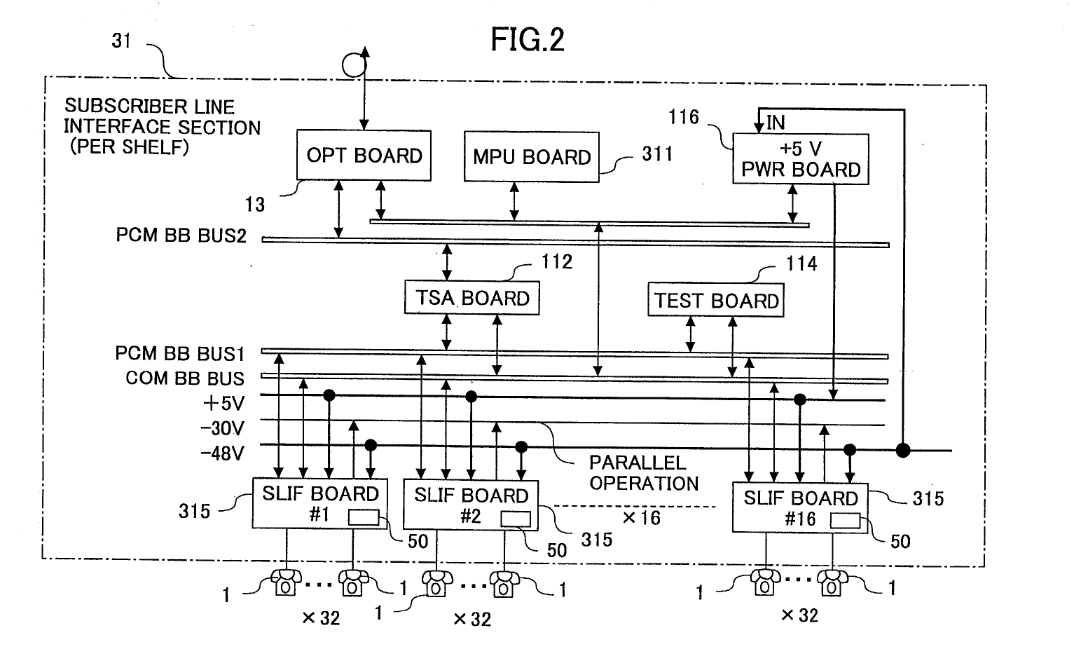

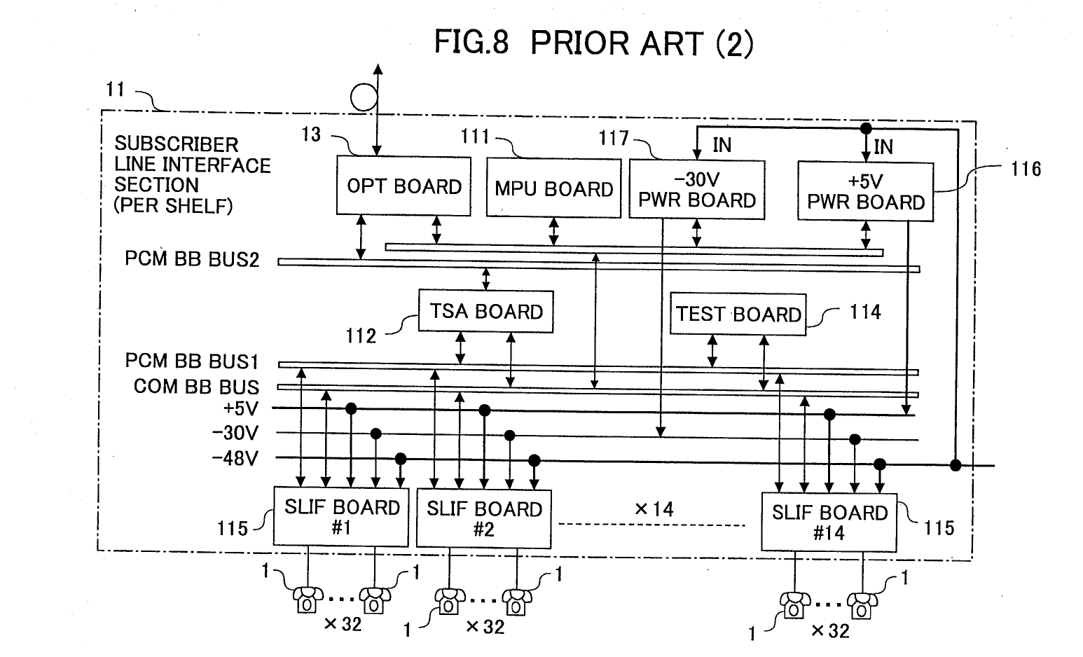

FIG. 2 shows a block diagram of a subscriber line interface section 31 in one embodiment of the present invention. The subscriber line interface section 31 according to the present invention (per shelf) includes a microprocessor unit (MPU) board 311 performing a common control inside the subscriber line interface section 31 and a maximum of 16 subscriber line interface (SLIF) boards 315 from #1 through #16, each capable of connecting to 32 analog subscriber lines (channels). The rest of the subscriber line interface section 31 may be configured similarly as described with reference to FIG. 8.

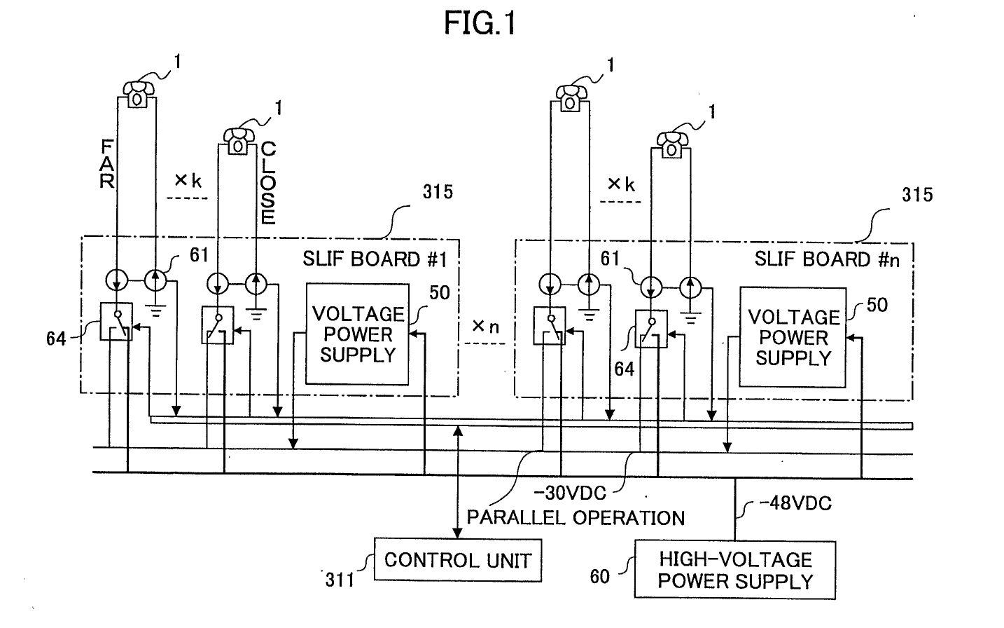

However, in the configuration shown in FIG. 2, the centralized −30 V PWR board 117 in FIG. 8 is eliminated and instead, a small-sized −30 VDC unit (−30 VDC-DC converter) 50 is distributed and installed in each of the subscriber line interface boards 315. It is noted that the −30 VDC unit 50 corresponds to a voltage power supply shown in FIG. 1. Further, −30 VDC outputs of each −30 VDC unit 50 are interconnected (shorted each other) by a −30 V power supply bus provided on the backboard (BB) of the shelf and each −30 VDC unit 50 is operated in parallel, and controlled so as to maintain its output voltage constant (i.e. −30 VDC).

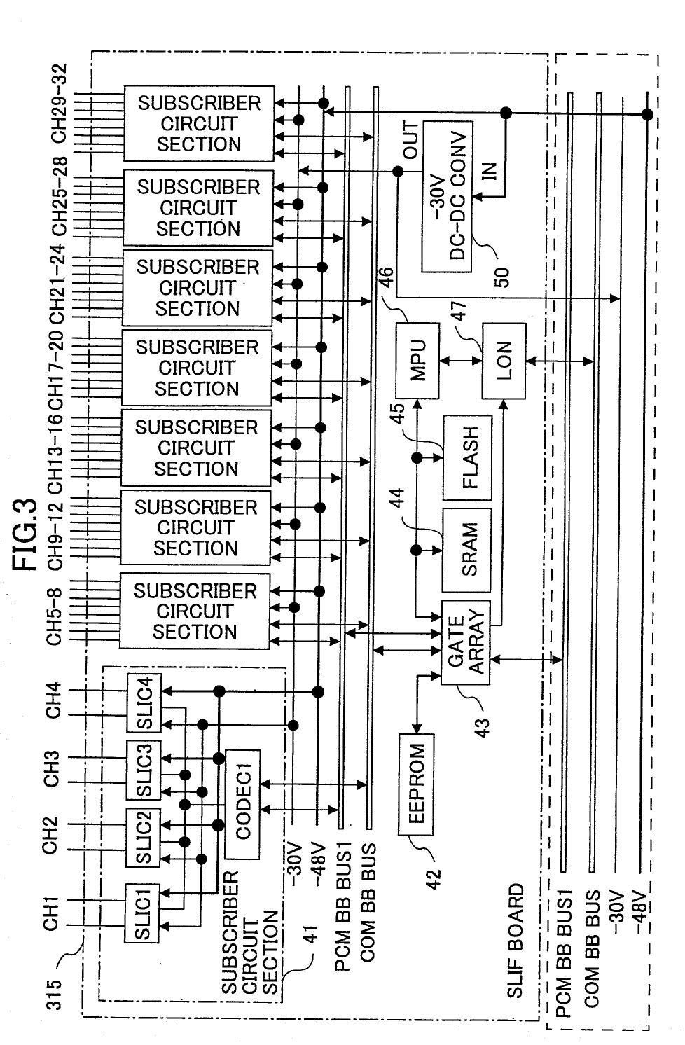

FIG. 3 shows a block diagram of a subscriber line interface (SLIF) board 315 in one embodiment of the present invention. In the embodiment shown, each SLIF board 315 is capable of connecting to 32 subscriber lines (channels). As shown, the subscriber line interface board 315 includes 8 subscriber circuit sections 41, each capable of connecting to 4 subscriber lines (channels) and includes 4 subscriber circuits (SLIC) and a codec (CODEC) for performing a conversion between analog speech signals and PCM speech data. Each subscriber circuit SLIC is provided with a BORSCHT function section, which is well known to those skilled in the art. Here, “B” stands for a Battery Feed section for feeding off-hook current to the metallic subscriber lines, “O” stands for an Over Voltage Protection circuit for protecting the subscriber circuits, “R” stands for a Ringing signal transmission circuit for ringing up the subscriber telephone, “S” stands for a Supervision circuit for receiving and supervising ringing/ringing-off, dial-pulses, etc., “C” stands for a Coder-decoder (codec) circuit for performing a conversion between analog speech signals and digital PCM signals, “H” stands for a two-to-four wire conversion Hybrid circuit for performing a signal conversion between 2-wire subscriber lines and 4-wire off-hook channels, and “T” stands for a Testing circuit for performing various tests on the subscriber lines and off-hook channels. There are 8 of such subscriber circuits, each connecting to 4 subscriber lines (channels), in the SLIF board 315, therefore a single SLIF board 315 can connect to a total of 32 subscriber lines.

The SLIF board 315 further includes a non-volatile memory (EEPROM) 42 for storing operational parameters, etc. of the SLIF board 315, a gate array (GATE ARRAY) 43 for interconnecting a plurality of buses in the SLIF board 315 (a PCM CH BUS associated with PCM data and a COM CH BUS associated with control signals) and a plurality of similar buses in the backboard of the shelf (a PCM BB BUS and a COM BB BUS), a microprocessor unit (MPU) 46 for performing main control and processing of the relevant SLIF board 315, a static random access memory (SRAM) 44 where the CPU 46 uses it as a working area, a flash memory (FLASH) 45 for storing application programs, etc. of the MPU 46, and a local operating network (LON) 47 for interconnecting the gate array 43 and the COM BB BUS.

Further, in the present embodiment, the −30 VDC unit 50 comprises a −30 VDC-DC converter, which generates an output (OUT) of−30 VDC when it receives −48 VDC as an input (IN) from the backboard power supply bus. The output of the −30 VDC-DC converter 50 is connected to each of the subscriber circuit sections 41 of the SLIF board 315 and, at the same time, is connected to a −30 VDC bus of the backboard which is common to the shelf. In this way, the plurality of the −30 VDC-DC converters 50 in the shelf are configured to operate in parallel, and thus a constant feeding of −30 VDC to a required number of or to any combination of the subscriber terminals 1 is possible. In short, even when the feeding capacity per unit of −30 VDC-DC converter is small (for example, 11 lines, which is 33% of the whole 32 lines) , since the feeding capacity of the −30 VDC-DC converters in other respective SLIF boards 315 can be shared with each other, a request for feeding all the 32 lines in a particular SLIF board with −30 VDC can be satisfied. In this way, the shelf itself can cover 169 subscriber lines, which is 33% of 512 lines, a total number of subscriber lines that can be connected to the shelf.

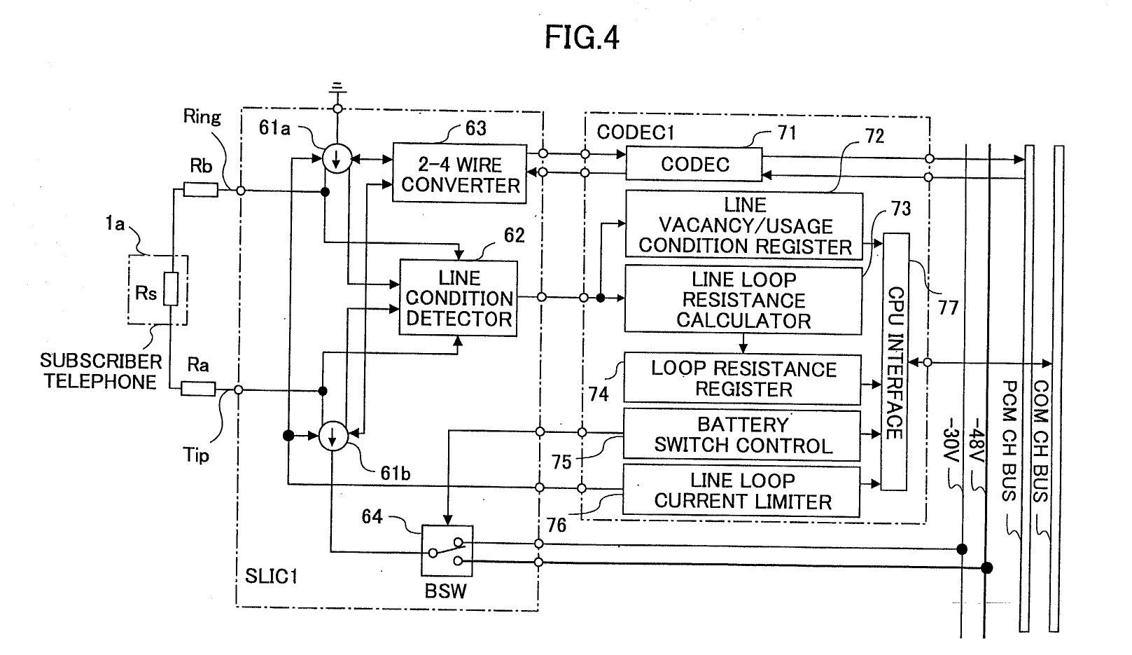

FIG. 4 shows a circuit diagram of a subscriber circuit (SILC) section 41 in one embodiment of the present invention, in which the configuration for a single subscriber line is shown. The subscriber circuit SLIC 1 includes current source circuits 61a and 61b for feeding off-hook current to metallic subscriber lines (Ring and Tip), a line condition detector 62 for detecting line vacancy/usage and line loop resistance, etc., a two-to-four wire converter 63, and a battery switch (BSW) 64 for switching between −48 VDC voltage and −30 VDC feeding voltage.

The codec section (CODEC) 1 includes a codec (CODEC) 71 for performing a conversion between analog speech signals and digital PCM data, a line vacancy/usage register 72 for keeping the line vacancy/usage condition detected by the line condition detector 62, a line loop resistance calculator 73 for calculating the line loop resistance, a line loop resistance register 74 for keeping the calculated line loop resistance, a battery switch controller 75, a line loop current limiter 76 for limiting the loop current flowing in the off-hook line to a predetermined value (for example, to 24 mA), and a CPU interface 77 for connecting to the MPU 46 shown in FIG. 3.

Further, Ra and Rb designate line resistance and Rs designates resistance of a subscriber telephone 1, and thus the line loop resistance is (Rb+Rs+Ra). Also, when the subscriber telephone is on-hook (disconnected), the loop current is small (the line loop resistance is small) and thus the line is open and available. When the subscriber telephone is off-hook (connected), the loop current is large (the lone loop resistance is large) and thus the line is occupied or busy.

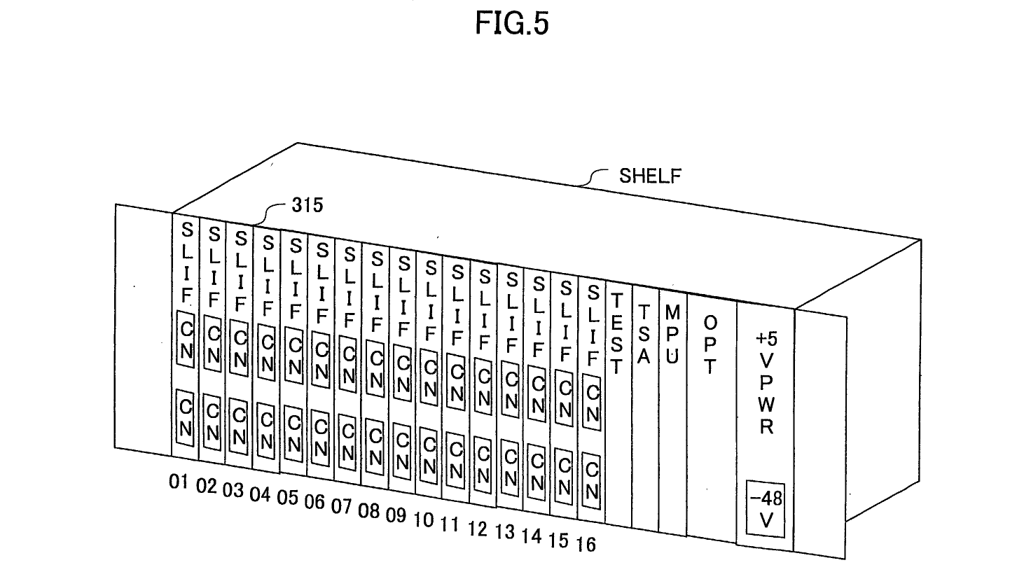

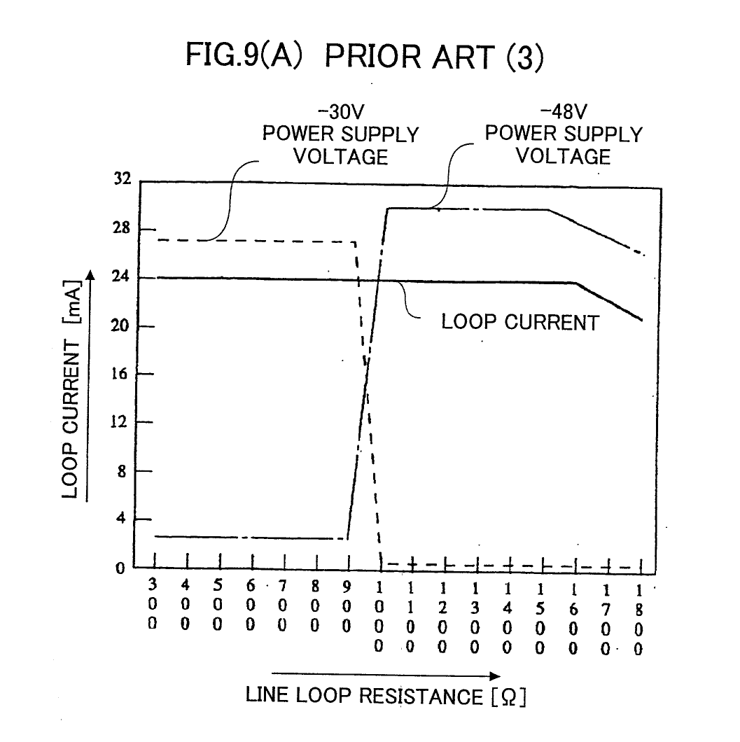

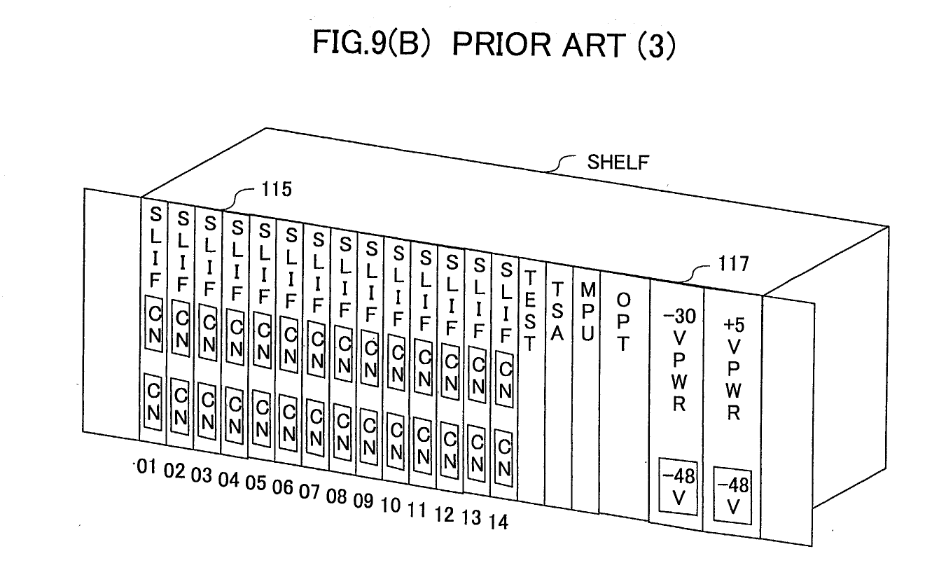

FIG. 5 is a mounted external view of the subscriber interface section 31 in one embodiment of the present invention. In FIG. 5, the centralized −30 V PWR board 117 shown in FIG. 9(B) is eliminated, as a result of which, an extra space for two more SLIF boards 315 in a shelf of the conventional size is available, which means a maximum of 16 subscriber line interface boards can be mounted in the shelf. Hence, with the present invention, it is possible to connect to a maximum of 512 subscriber lines (=32×16) per shelf. The following is a detailed description of a method of feeding control in one embodiment of the present invention.

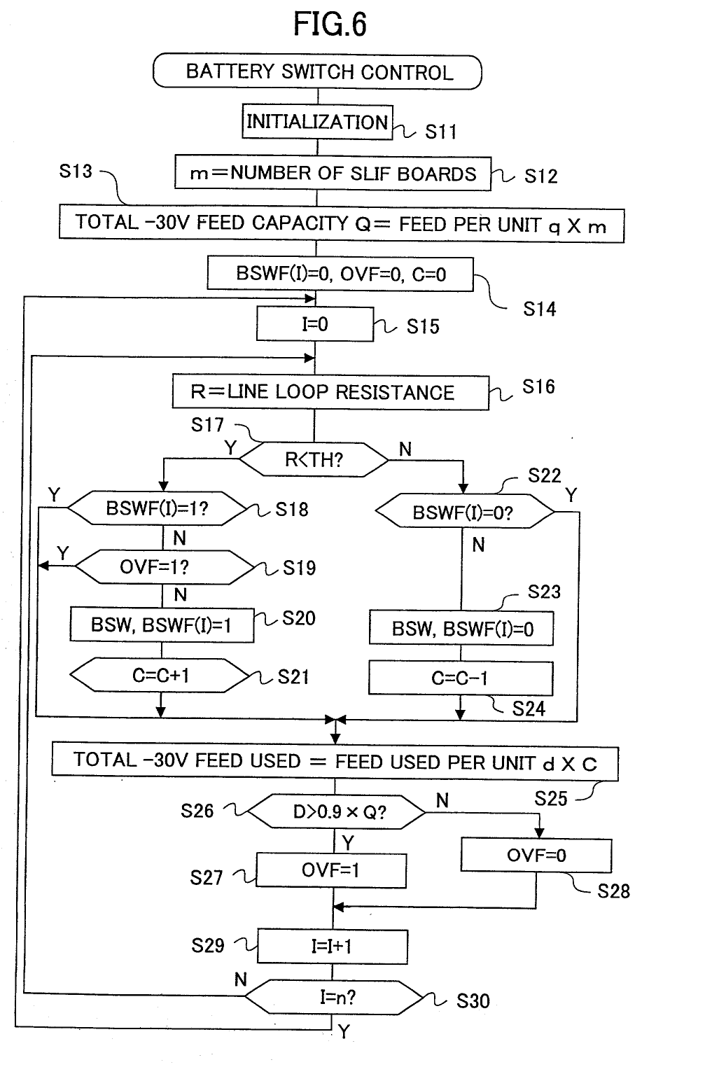

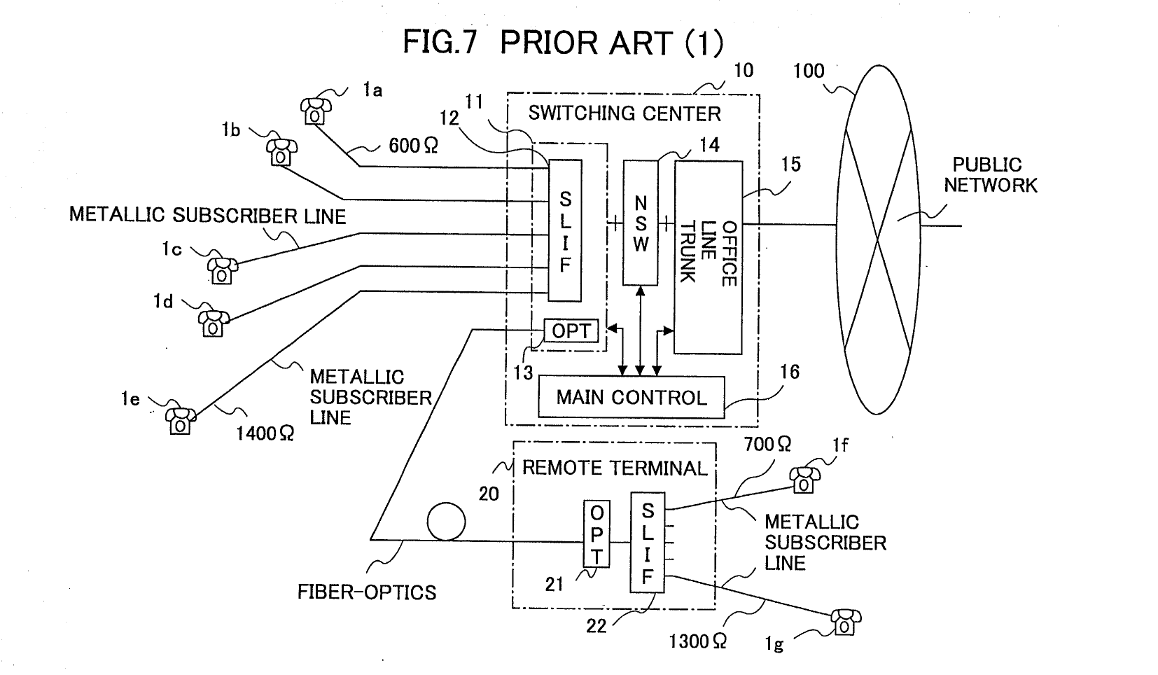

FIG. 6 shows a flow chart of a method of battery switching control in one embodiment of the present invention, carried out by the MPU board 311 (which is responsible for the common control inside the shelf) shown in FIG. 2 and the MPU 46 (which is responsible for the common control inside the SLIF board) shown in FIG. 3 cooperating together. Feeding to the device starts the process.

In step S11, the subscriber line interface section 31 is initialized. For example, all of the subscriber lines are set as to be uniformly fed with −48 VDC. In step S12, the number of SLIF boards actually mounted is counted and the resultant number m is stored in a memory register. The number of SLIF boards actually mounted is counted by, for example, having the MPU board 311 of the shelf sending an inquiry signal to each MPU 46 accommodated in respective LSIF boards 315, and determining that the LISF board is mounted if there is a response and that the LISF board is not mounted if there is no response. In step S13, an overall feeding capacity Q of the voltage power supplies in a shelf at the current moment is obtained from:

Q=q×m

wherein q is the feeding capacity per unit of −30 VDC-DC converter.

In step S14, various parameters needed for the battery switching control of the present invention are initialized. For example, a flag array BSWF (I) storing the ON/OFF conditions of the battery switches of all the lines (channels) is initialized to zero (which means that all the lines are fed with −48 VDC). Also, an electrical overload condition flag OVF, which determines whether the −30 VDC power supply is overloaded or not, is initialized to zero (which means that the −30 VDC power supply is not overloaded), and further, a line counter C, which counts the number of lines fed by the −30 VDC power supply, is initialized to zero. In step S16, line loop resistance of the line number #I (starts with #0) is detected and the resultant resistance R is stored in a memory register.

In step S17, it is determined whether the resultant resistance R is smaller or larger than a predetermined threshold TH (for example, TH=1000 Ω) (R<TH?). In a case of the resistance R is smaller than the predetermined threshold (R<TH), which means that the subscriber telephone is within a relatively close range, then id is determined if the flag BSWF (I) is 1 or not in step S18 (BSWF (I)=1 means that the line is already fed with −30 VDC) (BSWF (I)=1?). If the flag BSWF (I) is not 1, then it is determined if the flag OVF is 1 or not in step S19 (OVF=1 means that the −30 VDC power supply is overloaded or nearly overloaded). If the OVF is not 1, then the −30 VDC power supply is still available to feed −30 VDC and thus in step S20, the battery switch BSW of the relevant line is set to 1, which means that the relevant line is fed with −30 VDC (BSW=1) and also the flag BSWF (I) is set to 1 (BSWF (I)=1). In step S21, since the number of lines fed with −30 VDC is incremented by +1, the line counter C is added +1. When the flag BSWF (I) is already 1 (BSWF (I)=1) in step S18, which means that the relevant line is already fed with −30 VDC, or when the flag OVF is already 1 in step S19, which means that the −30 VDC power supply is overloaded or nearly overloaded, then the process proceeds directly to step S25.

In a case of the resistance R is larger than the predetermined threshold (R>TH), which mean that the subscriber telephone is at a relatively distant range, it is determined if the flag BSWF (I) is 0 or not in step S22 (BSWF (I)=0 means that the line is already fed with −48 VDC) (BSWF (I)=0?). If the BSWF (I) is not 0, then the battery switch BSW of the relevant line is set to 0, which means that the relevant line is fed with −48 VDC (BSW=0) and also the flag BSWF (I) is set to 0 (BSWF (I)=0). In step S24, since the number of lines fed with −30 VDC is incremented by −1, the line counter C is added −1. When the flag BSWF (I) is already 0 (BSWF (I)=0) in step S22, which means that the relevant line is already fed with −48 VDC, then the process proceeds directly to step S25. In step S25, a total amount of feeding currently used D is obtained from:

D=d×C

wherein d is a nominal amount of feeding used per subscriber line.

In step S26, it is determined whether the total amount of −30 VDC feeding used D is smaller or larger than 0.9×Q, wherein Q is the overall feeding capacity of −30 VDC. In a case of D>0.9×Q, the −30 VDC power supply is nearly overloaded and thus the flag OVF is set to 1 in step 27 (OVF=1). In case of D<0.9×Q, the −30 VDC power supply is still available to feed −30 VDC and thus the flag OVF is set to 0 (OVF=0). In step S29, the line number #I is incremented by +1 and in step S30, it is determined whether the maximum number (I=n) has been reached or not. In a case the line number #I is not n, which means that the line number is not the maximum number, then the line loop examination and the battery switching control for the next line is carried out. In a case of the line number #I is n, which means that the line number has reached the maximum number, the process is returned to step S15 and the line loop examination and the battery switching control are carried out from the very first line.

According to the embodiment of the present invention, even when the feeding capacity of the −30 VDC/DC converter 50 in respective SLIF boards 315 is set to, for example, 33%, it is possible to satisfy a request for feeding of −30 VDC to all the subscriber lines connected to a particular SLIF board 315. Also, even in a case when the request for feeding of −30 VDC temporarily exceeds 33%, the overloading of the −30 VDC power supply is prevented since the switching over to −30 VDC feeding by the battery switch 64 is suspended and this leads to improvement in the device reliability.

It is noted that in the embodiment of the present invention described above, although the total amount of feed currently used D is obtained from the calculation D=d×C, in which d is the nominal amount of feeding used per subscriber line, the invention is not limited thereto. Since a maximum value of the loop current in respective lines (such as 24 mA) can be set and controlled by the loop current limiter 76, a more precise amount of actual feeding used D can be obtained from; D={30 (d1+d2+ . . . )}, wherein di is a value of limited loop current in respective subscriber lines, which is collected by the MPU board 311.

Also, in the embodiment of the present invention described above, the resistance threshold TH for determining whether the relevant subscriber telephone is within a relatively close range or at a relatively distant range is set to 1000 Ω. however the present invention is not limited thereto. The threshold may be predetermined at random.

Having described preferred embodiments of the present invention, it is obvious that modification in the configuration, the method of controlling, the process, and any combination of the above without departing from the scope of the invention are feasible.

The present application is based on Japanese priority application No. 2001-357386, filed on Nov. 22, 2001, the entire contents of which are hereby incorporated by reference.

What is claimed is:

1. A subscriber line interface device capable of feeding a plurality of subscriber terminals connected thereto with different voltages, characterized in that the device includes:
a plurality of voltage power supplies, each voltage power supply distributed to each of a plurality of subscriber line interface boards respectively, each subscriber line interface board capable of connecting to a predetermined number of said subscriber terminals, in order to feed with a voltage lower than a maximum voltage among said different voltages.

2. The subscriber line interface device as claimed in claim 1, characterized in that:
feeding capacity of said voltage power supply is smaller than that needed for said predetermined number of said subscriber terminals.

3. The subscriber line interface device as claimed in claim 2, characterized in that:
a voltage power supply in a subscriber line interface board operates in parallel with other voltage power supplies distributed to other subscriber line interface boards, an output of the voltage power supply interconnecting to outputs of other voltage power supplies.

4. The subscriber line interface device as claimed in claim 3, characterized in that:
said voltage power supply is fed from a high-voltage power supply generating relatively high-voltage.

5. The subscriber line interface device as claimed in claim 4, characterized in that the device further includes:
a switch that switches the feeding to said plurality of said subscriber terminals between said high-voltage power supply and said voltage power supply, and
a control unit that monitors line loop resistance of each subscriber line of said plurality of subscriber terminals, and connects said switch to said voltage power supply for the subscriber terminals with its line loop resistance below a predetermined threshold, and connects said switch to said high-voltage power supply for the subscriber terminals with its line loop resistance over the predetermined threshold,
wherein, the control unit is configured not to connect said switch to said voltage power supplies when a total amount of feeding of said voltage power 'supplies to the subscriber terminals exceeds an overall amount of feeding capacity allowed to said voltage power supplies distributed to said plurality of subscriber line interface boards.

6. The subscriber line interface device as claimed in claim 5, characterized in that:
said control unit obtains the overall amount of feeding capacity allowed to said voltage power supplies distributed to said plurality of said subscriber line interface boards, from a product of the number of said subscriber line interface boards actually mounted and rated feeding capacity of each voltage power supply in respective subscriber line interface boards.

7. The subscriber line interface device as claimed in claim 5, characterized in that:
said control unit obtains the total amount of feeding of said voltage power supplies, from a product of the number of the subscriber terminals connected to said voltage power supplies and the power (for example, output voltage×a constant current) fed to each subscriber terminal.
